(19) United States
(12) Patent Application Publication
(10) Pub. No.: US 2021/0095132 A1
(43) Pub. Date: Apr. 1, 2021

(54) TREATED INORGANIC PARTICULATE MATERIALS AND METHODS FOR PREPARATION THEREOF

(71) Applicant: IMERTECH SAS, Paris (FR)

(72) Inventors: Ophélie ANJARD, Cornwall (GB); Anabelle ELTON-LEGRIX, St. Austell Cornwall (GB); Robert EADE, St. Austell (GB); Jonathan HEARLE, Falmouth Cornwall (GB)

(21) Appl. No.: 15/733,292

(22) PCT Filed: Dec. 21, 2018
(86) PCT No.: PCT/EP2018/086721

§ 371 Date: Jun. 22, 2020

(30) Foreign Application Priority Data
Dec. 22, 2017 (EP) 17275198.4

(51) Int. Cl. C09C 1/42; A01N 25/12; A01N 59/16

(52) U.S. Cl. CPC C09C 1/42; C01P 2004/61; A01N 59/16; A01N 25/12

(57) ABSTRACT

Systems and methods of treating an inorganic particulate material with an antimicrobial agent are discussed, including: introducing the inorganic particulate material and water to an air swept dryer; introducing the antimicrobial agent to the air swept dryer; and at least partially drying, and optionally at least partially pulverizing, the inorganic particulate material in the presence of the antimicrobial agent forming a treated inorganic particulate material, wherein at least a portion of the antimicrobial agent is exchanged onto and/or into the surface of the treated inorganic particulate material.

### FIELD OF THE INVENTION

Embodiments of the present disclosure relate generally to treatment of inorganic particulate materials with an antimicrobial agent, including the preparation of such materials and use thereof.

### BACKGROUND

Inorganic particulate materials have long been treated with agents of various kinds, including anti-microbial agents. Such treatments have primarily been performed in a solution, such as an aqueous solution, in order to allow sufficient time for cation exchange. The solution method then requires removal of the solvent introduced with the solution from the inorganic particulate material. In particular, the treatment of inorganic particulate materials, such as kaolin, with an anti-microbial agent is typically performed by impregnating the inorganic particulate material with a solution containing the anti-microbial agent.

Thus, given the inefficiencies, added complexity and increased cost of solution based treatments of inorganic particulate materials, there is an incentive to discover and develop other methods for treating inorganic particulate materials.

### SUMMARY OF THE DISCLOSURE

The present disclosure includes a method of treating an inorganic particulate material with an antimicrobial agent, including: introducing a first feed including the inorganic particulate material and water to an air swept dryer; introducing a second feed including the antimicrobial agent to the air swept dryer; and at least partially drying the inorganic particulate material of the first feed in the presence of the antimicrobial agent of the second feed forming a treated inorganic particulate material, wherein at least a portion of the antimicrobial agent is exchanged onto and/or into the surface of the inorganic particulate material.

In a further aspect of the disclosure, the inorganic particulate material is a particulate phyllosilicate mineral.

In a further aspect of the disclosure, the antimicrobial agent can include a metal, or metal salt, selected from the group consisting of silver, copper, zinc and combinations thereof.

In a further aspect of the disclosure, the inorganic particulate material introduced in the first feed is in the form of a powder having a median particle size by laser scattering D50 of less than about 5 microns.

In a further aspect of the disclosure, the inorganic particulate material introduced in the first feed is in the form of lumps having an average aggregate size of about 1 to about 3 cm.

In a further aspect of the disclosure, the inorganic particulate material introduced in the first feed is in the form of a spray dried material having an average aggregate size of about 50 to about 250 microns.

A further aspect of the disclosure includes a method of treating an inorganic particulate material with an antimicrobial agent, including: at least partially pulverizing and drying the inorganic particulate material having an average aggregate size of about 1 to about 3 centimeters in the presence of the antimicrobial agent, and in the presence of less than about 25 wt % water forming a treated inorganic particulate material; wherein at least a portion of the antimicrobial agent is exchanged onto the surface and/or into the pores of the treated inorganic particulate material.

### BRIEF DESCRIPTION OF THE DRAWINGS

The accompanying drawings, which are incorporated in and constitute a part of this specification, illustrate various exemplary aspects of the disclosure, and together with the description, serve to explain the principles of the present disclosure.

FIG. 1 is a schematic view of an inorganic particulate processing system in accordance with an embodiment of the present disclosure.

FIG. 2 is a schematic view of an inorganic particulate processing system in accordance with an embodiment of the present disclosure.

### DETAILED DESCRIPTION

Particular aspects of the present disclosure are described in greater detail below. The terms and definitions provided herein control, if in conflict with terms and/or definitions incorporated by reference.

In the Summary above and in the Detailed Description, and the claims below, and in the accompanying drawings, reference is made to particular features (including method steps) of the disclosure. It is understood that the present disclosure includes all possible combinations of such particular features. For example; where a particular feature is disclosed in the context of a particular aspect or embodiment, or a particular claim, that feature can also be used, to the extent possible in combination with and additionally or alternatively in the context of other particular aspects or embodiments of the disclosure and, in the disclosure generally.

As used herein, the terms “comprises,” “comprising,” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal.”

As used herein, the singular forms “a,” “an,” and “the” include plural reference unless the context dictates otherwise. The terms “approximately” and “about” refer to being nearly the same as a referenced number or value. As used herein, the terms “approximately” and “about” should be understood to encompass ±5% of a specified amount or value.

When a range is used herein as “ranging from (a first number)” to (a second number),” “between (a first number) and (a second number),” or “(a first number)-(a second number),” this refers to a range whose lower limit is the first number, and whose upper limit is the second number. As used herein, the term “at least” followed by a number denotes the start of a range beginning with that number, which may be a range having an upper limit or no upper limit depending on the variable term being defined. For example, “at least 1” includes 1 and more than 1.

Particle Size Distribution (PSD)

The particle size of powder is defined by laser diffraction. A parallel laser beam passes through a dispersed particulate sample suspended in air and the angular variation in intensity of the scattered light is measured. Small particles scatter light at large angles relative to the initial laser beam and large particles scatter light at smaller angles. The angular scattering intensity data is then analyzed using Fraunhofer light scattering theory to calculate the size of the particles. The median particle size is defined by the value D50, wherein 50 percent (by volume) of the particle population has a size below the D50 value. D50 is the median average spherical diameter of the particles.

The present disclosure includes processes and systems for treating inorganic particulate materials with an anti-microbial agent and comprises, consists of, or consists essentially of: i) introducing a first feed comprising the inorganic particulate material and water to an air swept dryer; ii) introducing a second feed comprising the antimicrobial agent to the air swept dryer; and iii) at least partially drying the inorganic particulate material of the first feed in the presence of the antimicrobial agent of the second feed forming a treated inorganic particulate material, wherein at least a portion of the antimicrobial agent is exchanged onto and/or into the surface of the treated inorganic particulate material. The second feed can be an aqueous feed or a dry feed.

In accordance with an embodiment, the inorganic particulate material introduced in the first feed can be in the form of a powder having a median particle size as a dry suspension by light scattering (hereinafter referred to as “D₅₀”) of less than about 5 or less than about 4 or less than about 3, or less than about 2 or less than about 1 microns. In accordance with this embodiment, the at least partial drying the inorganic particulate material of the first feed in the presence of the antimicrobial agent of the second feed is in the presence of water in the range of from about 0.1 to about 10 or about 1 to about 8 or about 3 to about 7 wt % water.

In accordance with an embodiment, the inorganic particulate material introduced in the first feed can be in the form of a spray dried material having an average aggregate size of about 50 to about 250, or about 70 to about 230, or about 100 to about 200 microns. In accordance with this embodiment, the at least partial drying the inorganic particulate material of the first feed in the presence of the antimicrobial agent of the second feed is in the presence of water in the range of from about 0.2 to about 15 or about 1 to about 11 or about 3 to about 10 wt % water.

In accordance with an embodiment, the inorganic particulate material introduced in the first feed can be in the form of lumps having an average aggregate size of about 1 to about 3 cm, or of about 1.2 to about 2.7 cm, or of about 1.5 to about 2.5 cm. The inorganic particulate material can be at least partially pulverized in the air swept dryer forming the treated inorganic particulate material in the form of powder with a D₅₀ of less than about 5 or less than about 4 or less than about 3 or less than about 2 microns. In accordance with this embodiment, the at least partial drying the inorganic particulate material of the first feed in the presence of the antimicrobial agent of the second feed is in the presence of water in the range of from about 5 to about 25 or about 10 to about 23 or about 13 to about 20 wt % water.

In accordance with an embodiment, the first feed can contain from about 0.1 to about 20 wt % water. For inorganic particulate materials in the form of a powder as described herein, the first feed can contain from about 0.1 to about 2, or about 0.3 to about 1.5 or about 0.5 to about 1 wt % water. For inorganic particulate materials in the form of a spray dried material as described herein, the first feed can contain from about 0.1 to about 5, or about 0.2 to about 3 or about 0.3 to about 2 wt % water. For inorganic particulate materials in the form of lumps as described herein, the first feed can contain from about 5 to about 20, or about 7 to about 18 or about 8 to about 15 wt % water.

In accordance with an embodiment, a method of treating an inorganic particulate material with an antimicrobial agent, comprises, consists of, or consists essentially of: i) at least partially pulverizing and drying the inorganic particulate material having a median particle size by laser scattering D₅₀ of less than about 5 or less than about 4 or less than about 3, or less than about 2 or less than about 1 microns in the presence of the antimicrobial agent, and in the presence of about 0.1 to about 10 or about 1 to about 8 or about 3 to about 7 wt % water forming a treated inorganic particulate material; wherein at least a portion of the antimicrobial agent is exchanged onto the surface and/or into the pores of the treated inorganic particulate material.

In accordance with an embodiment, a method of treating an inorganic particulate material with an antimicrobial agent, comprises, consists of, or consists essentially of: i) at least partially pulverizing and drying the inorganic particulate material having an average aggregate size of about 50 to about 250, or about 70 to about 230, or about 100 to about 200 microns in the presence of the antimicrobial agent, and in the presence of from about 0.2 to about 15 or about 1 to about 11 or about 3 to about 10 wt % water forming a treated inorganic particulate material; wherein at least a portion of the antimicrobial agent is exchanged onto the surface and/or into the pores of the treated inorganic particulate material.

In accordance with an embodiment, a method of treating an inorganic particulate material with an antimicrobial agent, comprises, consists of, or consists essentially of: i) at least partially pulverizing and drying the inorganic particulate material having an average aggregate size of about 1 to about 3, or about 1.2 to about 2.7 cm, or about 1.5 to about 2.5 cm in the presence of the antimicrobial agent, and in the presence of less than about 25 or 23 or 20 wt % water forming a treated inorganic particulate material; wherein at least a portion of the antimicrobial agent is exchanged onto the surface and/or into the pores of the treated inorganic particulate material.

In accordance with an embodiment, the first and second feeds can be combined prior to introduction to the air swept dryer.

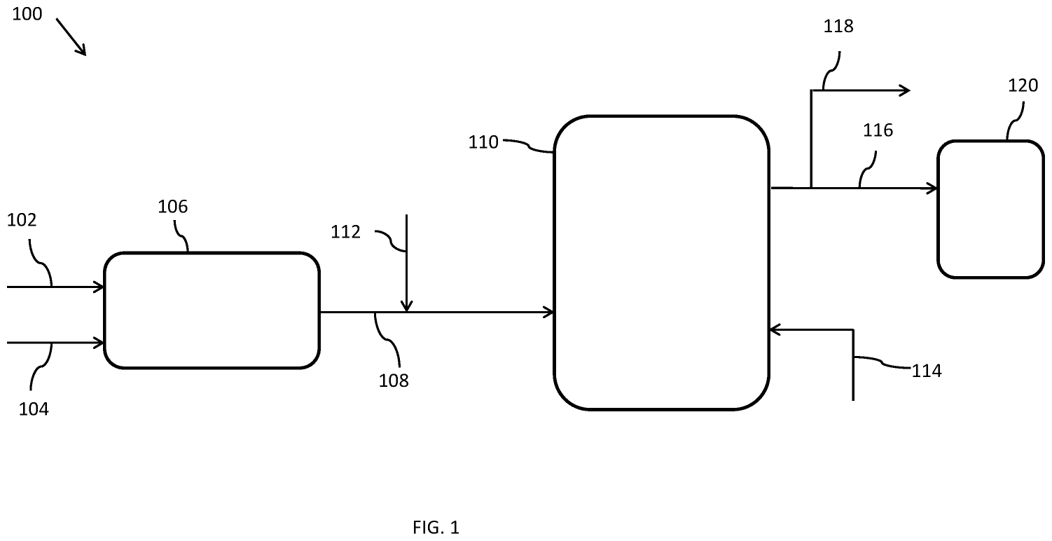

With reference to FIG. 1, a process and system 100 is disclosed in accordance with an embodiment of the disclosure wherein an air feed 102 and a burner fuel feed 104 are charged to a burner 106. A combustion gas then passes via gas stream line 108 from burner 106 to air swept dryer 110. The inorganic particulate material is introduced to gas stream line 108 for contact with the combustion gas via line 112. The combustion gas and inorganic particulate material are then passed to air swept dryer 110 via line 108. The inlet temperature of the combustion gas and inorganic particulate material passed to air swept dryer 110, as referred to in the description and examples, is measured in line 108 at the entrance to air swept dryer 110. The antimicrobial agent is introduced to air swept dryer 110 via line 114, and a treated inorganic particulate material is removed along with the combustion gas from the air swept dryer 110 via line 116. The outlet temperature from the air swept dryer 110, as referred to in the description and examples, is measured in line 116 at the exit from air swept dryer 110. The combustion gas is separated from the treated inorganic particulate material via line 118 and the treated inorganic particulate material is passed to bag filter 120 via line 116 for collection. The inorganic particulate material can also be pulverized in the air swept dryer 110 along with being dried. The air swept drier 110 can include rotating blades (not shown) having a small gap at the tip of the rotating blades, and pulverization of the inorganic particulate material can be achieved by passing the kaolin through the small gap.

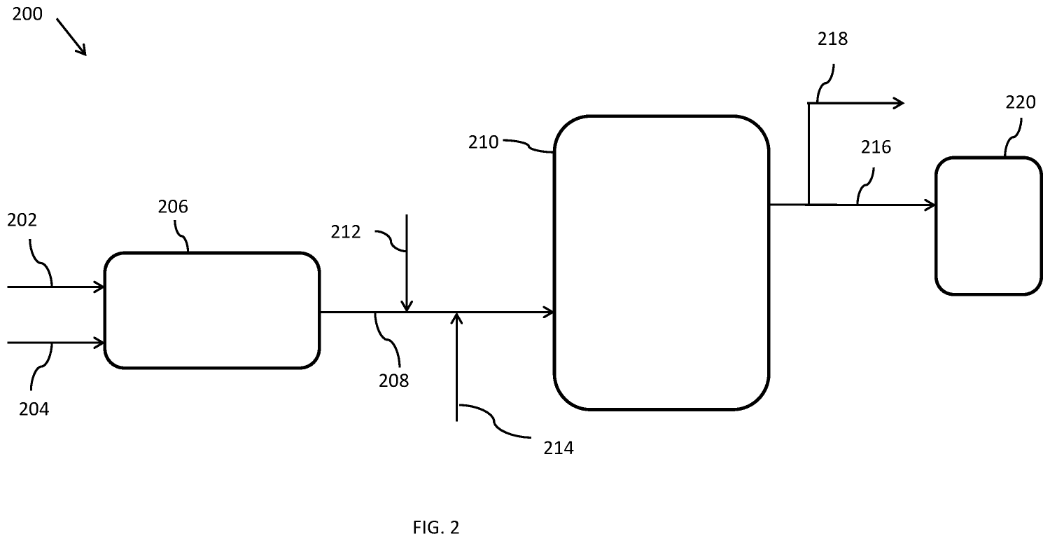

With reference to FIG. 2, a process and system 200 is disclosed in accordance with an embodiment of the disclosure wherein an air feed 202 and a burner fuel feed 204 are charged to a burner 206. A combustion gas then passes via gas stream line 208 from burner 206 to air swept dryer 210. The inorganic particulate material is introduced to gas stream line 208 via line 212; and an antimicrobial agent is introduced to gas stream line 208 via line 214. The combustion gas, inorganic particulate material and antimicrobial agent are then passed to air swept dryer 210 via line 208. The inlet temperature of the combustion gas, inorganic particulate material and antimicrobial agent passed to air swept dryer 210, as referred to in the description and examples, is measured in line 208 at the entrance to air swept dryer 210. A treated inorganic particulate material is removed along with the combustion gas from the air swept dryer 210 via line 216. The outlet temperature from the air swept dryer 210, as referred to in the description and examples, is measured in line 216 at the exit from air swept dryer 210. The combustion gas is separated from the treated inorganic particulate material via line 218 and the treated inorganic particulate material is passed to bag filter 220 via line 216 for collection. The inorganic particulate material can also be pulverized in the air swept dryer 210 along with being dried. The air swept drier 210 can include rotating blades (not shown) having a small gap at the tip of the rotating blades, and pulverization of the inorganic particulate material can be achieved by passing the kaolin through the small gap.

In accordance with the embodiments disclosed in the instant application, the inorganic particulate material can be a particulate phyllosilicate mineral. The particulate phyllosilicate mineral can be selected from the group consisting of kaolin, talc, mica, bentonite, and combinations thereof.

In accordance with the embodiments disclosed in the instant application, the antimicrobial agent comprises a metal or metal salt selected from the group consisting of silver, copper, zinc and combinations thereof. The antimicrobial agent can comprise silver nitrate.

In accordance with an embodiment, the treated inorganic particulate material can comprise less than about 2 wt % or less than 1 wt % or less than 0.5 wt % water, and at least about 10 microgram/gram (μg/g) or at least about 100 μg/g or at least about 0.1 wt % or at least about 0.5 wt % or at least about 0.8 wt % or at least about 1 wt % of the antimicrobial agent.

In accordance with an embodiment, the outlet temperature from the air swept dryer can be in the range of from about 50 to about 200° C., or about 60 to about 150° C., or about 80 to about 130° C.

In accordance with an embodiment, the antimicrobial agent can be added to the inorganic particulate material during the pulverizing and drying.

### EXAMPLES

The following examples are intended to illustrate the present disclosure without, however, being limiting in nature. It is understood that the present disclosure encompasses additional aspects and embodiments consistent with the foregoing description and following examples.

A kaolin feed having 8.5% moisture and a D50 of 1.5 μm was used in the following trials as described in Table 1. The kaolin feed was charged to an air swept dryer (which was an Atritor cell-mill model CM250) at a rate of 125 kg/hr at an inlet temperature of 180° C. along with a combustion gas. A silver nitrate solution was then added into the air-swept dryer and mixed along with the kaolin. The kaolin and solution were pulverized within a few seconds inside the air swept drier (110 in FIG. 1 and 210 in FIG. 2). The pulverization was accomplished by passing the kaolin through a small gap at the tip of rotating blades contained within the air swept drier which rotated at a speed of about 6000 rpm. The dried treated kaolin was then collected with an outlet temperature of 90° C. The final product was tested for the silver content using XRF-Protrace. Three different concentrations were made: 200, 500, 1000 μg Ag/g kaolin with the addition of different volume of solution for 200 μg Ag/g kaolin. The leaching of silver on the treated kaolin was tested, to make sure the metal was exchanged onto and/or into the surface of the mineral by placing 10 g of the sample in 100 mL water for 30 minutes, filtered and then the amount of silver on the dry powder was measured by XRF-Protrace with an error of ±10 μg/g. The results are shown in Table 1 below.

TABLE 1

| | | | | | | Treated |
|---|---|---|---|---|---|---|
| | | | AgNO₃ | | Treated | Kaolin |
| | Target | Target | Solution | Volume | Kaolin | Ag μg/g |
| | Ag μg/g | AgNO₃ | strength | added | Ag μg/g | after |
| Kaolin | of kaolin | μg/g | wt % | mL/min | measured | leaching |
| A | 200 | 310 | 0.6 | 101 | 190 | 179 |
| B | | | 1.5 | 40 | 173 | 173 |
| C | | | 3 | 20 | 170 | 174 |
| D | 500 | 790 | 1.5 | 101 | 439 | 428 |
| E | 1000 | 157 | 3 | 101 | 902 | 828 |

The addition of an increasing volume of AgNO₃ solution did not influence the final moisture that was at −0.6 wt % for each of the runs, and did not influence the exchange of silver into the kaolin as the concentrations and leaching were similar for 20, 40, and 101 mL of solution injected per minute for a concentration of 200 μg/g,

The antibacterial efficiency of the treated kaolin was tested in a matt paint reference formulation for in-can stability at different levels. Seven different paints were made and tested for their stability against bacteria. Paints A-C were controls: A and B containing biocides whereas C did not contain any biocides. Paints D-G contained silver treated kaolins A, C, D, E from Table 1 according to the invention.

A test of sterility was made prior to the in-can challenge test to make sure that none of the Paints A-G were contaminated prior to testing. The test consisted of placing 0.1 g (equal to around 0.1 ml) of the Paints A-G on the following culture media:

Tryptic Soy Agar (TSA) for bacterial counts (incubation: 5 days at 30° C.±2° C.)

Malt Extract+Chloramphenicol agar, selective medium for yeast and mould counts (incubation: 5 days at 23° C.±2° C.).

The microbial counts are expressed in “colony forming units” per gram or per milliliter of product (CFU/g or CFU/ml) and 10 CFU/g is the detection limit. All samples were below 10 CFU/g.

An in-can test was performed in order to test the antibacterial properties of the treated kaolin in paint. This test follows the method for evaluating the resistance of water-based paints to bacterial growth in the wet-state developed by the international bio-deterioration research group (IBRG). For this test, samples were stored at ambient temperature for the duration of the test. Five (5) inoculations were performed once a week over six (6) weeks: 1 ml of the inoculum was added to 50 g of paint. The inoculum was composed of the described microorganism in Table 2.

TABLE 2

| | |
|---|---|
| Microorganism | Reference |

Bacteria

| | |
|---|---|
| Alcaligenes faecalis | DSM 30030 |
| Burkholderia cepacia | ATCC 25146 |
| Enterobacter aerogenes | ATCC 13048 |
| Proteus hauseri | DSM 30118 |
| Pseudomonas aeruginosa | DSM 939 |
| Pseudomonas fluorescens | DSM 50090 |
| Pseudomonas putida | DSM 291 |

Yeast

| | |
|---|---|
| Candida lipolytica | DSM 8218 |
| Saccharomyces cerevisiae | ATCC 2601 |

Mould

| | |
|---|---|
| Aspergillus brasiliensis | ATCC 16404 |
| Penicillium ochrochloron | DSM 1945 |

Inoculum concentration: bacteria ≈ 10⁸ CFU/ml
yeast & mould ≈ 10⁶ CFU/ml

To assess contamination following each inoculation, a 0.1 ml amount of the sample was surface-plated in triplicate on the following culture media:
Tryptic Soy Agar (TSA) for bacterial counts (incubation: 5-7 days at 30° C.±2° C.)
Malt Extract+Chloramphenicol agar, selective medium for yeast and mould counts (incubation: 5-7 days at 23° C.±2° C.).

The results are summarized in Table 3 below.

TABLE 3

| | Paint A | Paint B | Paint C | Paint D | Paint E | Paint F | Paint G |
|---|---|---|---|---|---|---|---|
| | (control) | (control) | (control) | (kaolin E) | (kaolin A) | (kaolin C) | (kaolin D) |
| Biocide¹ wt % | 0.15 | 0.075 | 0 | 0 | 0 | 0 | |
| in Paint | | | | | | | |
| Fungicide² | 0.16 | 0.065 | 0 | 0 | 0 | 0 | |
| wt % in Paint | | | | | | | |
| Ag μg/g in | — | — | — | 902 | 190 | 170 | 439 |
| Treated Kaolin | | | | | | | |
| Treated Kaolin | — | — | — | 0.56 | 1.18 | 2.63 | 0.8 |
| in Paint, wt % | | | | | | | |
| μg/g Ag in | — | — | — | 5 | 2 | 5 | 3.5 |
| Paint | | | | | | | |
| Sterility | <10 CFU/g | <10 CFU/g | <10 CFU/g | <10 CFU/g | <10 CFU/g | <10 CFU/g | <10 CFU/g |
| Number of | I-5 | I-5 | I-3 | I-5 | I-5 | I-5 | I-5 |
| inoculations | | | | | | | |
| without | | | | | | | |
| contamination | | | | | | | |

¹Acticide MBS biocide
²Rocima 350 fungicide
* I-5—Optimal/good; I-4—Moderate; I-3—Inefficient

Embodiments of the present disclosure may be as defined in the following numbered paragraphs:
1. A method of treating an inorganic particulate material with an antimicrobial agent, comprising:
   i) introducing a first feed comprising the inorganic particulate material and water to an air swept dryer;
   ii) introducing a second feed comprising the antimicrobial agent to the air swept dryer; and
   iii) at least partially drying the inorganic particulate material of the first feed in the presence of the antimicrobial agent of the second feed forming a treated inorganic particulate material, wherein at least a portion of the antimicrobial agent is exchanged onto and/or into the surface of the treated inorganic particulate material.
2. A method according to paragraph 1 wherein the inorganic particulate material introduced in the first feed is in the form of a powder having a median particle size by laser scattering D₅₀ of less than about 5 microns.
3. A method according to paragraph 1 wherein the inorganic particulate material introduced in the first feed is in the form of lumps having an average aggregate size of about 1 to about 3 cm.
4. A method according to paragraph 1 wherein the inorganic particulate material introduced in the first feed is in the form of a spray dried material having an average aggregate size of about 50 to about 250 microns.
5. A method according to any of paragraphs 2-4 further comprising at least partially pulverizing the inorganic particulate material in the presence of the antimicrobial agent in the air swept dryer forming the treated inorganic particulate material in the form of powder with a particle size D₅₀ of less than 5 microns.
6. A method according to any of paragraphs 1-5 wherein the inorganic particulate material is a particulate phyllosilicate mineral.
7. A method according to paragraph 6 wherein the particulate phyllosilicate mineral is selected from the group consisting of kaolin, talc, mica, bentonite, and combinations thereof.
8. A method according to any of paragraphs 1-7 wherein the antimicrobial agent comprises a metal or metal salt selected from the group consisting of silver, copper, zinc and combinations thereof.
9. A method according to any of paragraphs 1-8 wherein the antimicrobial agent comprises silver nitrate.
10. A method according to any of paragraphs 1-9 wherein the second feed is aqueous.
11. A method according to any of paragraphs 1-9 wherein the second feed is a dry feed.
12. A method according to any of paragraphs 1-11 wherein the first and second feeds are combined prior to introduction to the air swept dryer.
13. A method according to any of paragraphs 1-12 wherein the first feed contains from about 0.1 to about 20 wt % water.
14. A method according to any of paragraphs 1-13 wherein the treated inorganic particulate material comprises less than about 2 wt % or less than 1 wt % or less than 0.5 wt % water, and at least about 10 μg/g or at least about 100 μg/g or at least about 0.1 wt % or at least about 0.5 wt % or at least about 0.8 wt % or at least about 1 wt % of the antimicrobial agent.
15. A method according to any of paragraphs 1-14 wherein the outlet temperature from the air swept dryer is in the range of about 50 to about 200° C.
16. A method of treating an inorganic particulate material with an antimicrobial agent, comprising:
   at least partially pulverizing and drying the inorganic particulate material having an average aggregate size of about 1 to about 3 cm in the presence of the antimicrobial agent, and in the presence of less than about 25 wt % water forming a treated inorganic particulate material; wherein at least a portion of the antimicrobial agent is exchanged onto the surface and/or into the pores of the treated inorganic particulate material.
17. A method according to paragraph 16 wherein the antimicrobial agent is added to the inorganic particulate material during the pulverizing and drying.
18. A method according to any of paragraphs 16-17 wherein the outlet temperature of the treated inorganic particulate material after drying is in the range of from about 50 to about 200° C.
19. A method according to any of paragraphs 16-18 wherein the inorganic particulate material is selected from the group consisting of a particulate phyllosilicate mineral.
20. A method according to any of paragraphs 16-19 wherein the particulate phyllosilicate mineral is selected from the group consisting of kaolin, talc, mica, and combinations thereof.
21. A method according to any of paragraphs 16-20 wherein the antimicrobial agent comprises a metal or metal salt selected from the group consisting of silver, copper, and combinations thereof.
22. A method according to any of paragraphs 16-21 wherein the antimicrobial agent comprises silver nitrate.
23. A method according to any of paragraphs 16-22 wherein the pulverizing and drying is in the presence of from about 5 to about 25 wt % water.
24. A method according to any of paragraphs 16-23 wherein the treated inorganic particulate material comprises less than about 2 wt % or less than 1 wt % or less than 0.5 wt % water, and at least about 10 μg/g or at least about 100 μg/g or at least about 0.1 wt % or at least about 0.5 wt % or at least about 0.8 wt % or at least about 1 wt %.

It is intended that the specification and examples therein be considered as exemplary only, with a true scope and spirit of the present disclosure being indicated by the following claims.

1. A method of treating a particulate phyllosilicate material with an antimicrobial agent, comprising:
i) introducing a first feed comprising the particulate phyllosilicate material and water to an air swept dryer;
ii) introducing a second feed comprising the antimicrobial agent to the air swept dryer; and
iii) at least partially drying the inorganic particulate material of the first feed in the presence of the antimicrobial agent of the second feed forming a treated inorganic particulate material, wherein at least a portion of the antimicrobial agent is exchanged onto and/or into the surface of the treated inorganic particulate material; and wherein the antimicrobial agent comprises a metal or metal salt selected from the group consisting of silver, copper, zinc and combinations thereof.

2. A method according to claim 1 wherein the inorganic particulate material introduced in the first feed is in the form of a powder having a median particle size by laser scattering D₅₀ of less than about 5 microns.

3. A method according to claim 1 wherein the inorganic particulate material introduced in the first feed is in the form of lumps having an average aggregate size of about 1 to about 3 cm.

4. A method according to claim 1 wherein the inorganic particulate material introduced in the first feed is in the form of a spray dried material having an average aggregate size of about 50 to about 250 microns.

5. A method according to claim 2 further comprising at least partially pulverizing the inorganic particulate material in the presence of the antimicrobial agent in the air swept dryer forming the treated inorganic particulate material in the form of powder with a particle size D₅₀ of less than 5 microns.

6. A method according to claim 1 wherein the particulate phyllosilicate mineral is selected from the group consisting of kaolin, talc, mica, bentonite, and combinations thereof.

7. A method according to claim 1 wherein the antimicrobial agent comprises silver nitrate.

8. A method according to claim 1 wherein the second feed is aqueous.

9. A method according to claim 1 wherein the second feed is a dry feed.

10. A method according to claim 1 wherein the first and second feeds are combined prior to introduction to the air swept dryer.

11. A method according to claim 1 wherein the first feed contains from about 0.1 to about 20 wt % water.

12. A method according to claim 1 wherein the treated inorganic particulate material comprises less than about 2 wt % water, and at least about 10 μg/g of the antimicrobial agent.

13. A method according to claim 1 wherein the outlet temperature from the air swept dryer is in the range of about 50 to about 200° C.

14. A method according to claim 5, wherein:
the first feed contains from about 0.1 to about 20 wt % water,
the first and second feeds are combined prior to introduction to the air swept dryer,
the outlet temperature from the air swept dryer is in the range of about 50 to about 200° C., and
the treated inorganic particulate material comprises less than about 2 wt % water and at least about 10 μg/g of the antimicrobial agent.

15. A method according to claim 14, wherein the particulate phyllosilicate mineral is selected from the group consisting of kaolin, talc, mica, bentonite, and combinations thereof and the antimicrobial agent comprises silver nitrate.

16. A method according to claim 3 further comprising at least partially pulverizing the inorganic particulate material in the presence of the antimicrobial agent in the air swept dryer forming the treated inorganic particulate material in the form of powder with a particle size D₅₀ of less than 5 microns.

17. A method according to claim 16, wherein:
the first feed contains from about 0.1 to about 20 wt % water,
the first and second feeds are combined prior to introduction to the air swept dryer,
the outlet temperature from the air swept dryer is in the range of about 50 to about 200° C., and
the treated inorganic particulate material comprises less than about 2 wt % water and at least about 10 μg/g of the antimicrobial agent.

18. A method according to claim 17, wherein the particulate phyllosilicate mineral is selected from the group consisting of kaolin, talc, mica, bentonite, and combinations thereof and the antimicrobial agent comprises silver nitrate.

19. A method according to claim 4 further comprising at least partially pulverizing the inorganic particulate material in the presence of the antimicrobial agent in the air swept dryer forming the treated inorganic particulate material in the form of powder with a particle size D₅₀ of less than 5 microns.

20. A method according to claim 19, wherein:
the first feed contains from about 0.1 to about 20 wt % water,
the first and second feeds are combined prior to introduction to the air swept dryer,
the outlet temperature from the air swept dryer is in the range of about 50 to about 200° C.,
the treated inorganic particulate material comprises less than about 2 wt % water and at least about 10 μg/g of the antimicrobial agent;
the particulate phyllosilicate mineral is selected from the group consisting of kaolin, talc, mica, bentonite, and combinations thereof; and
the antimicrobial agent comprises silver nitrate.
